(19) United States
(12) Patent Application Publication
(10) Pub. No.: US 2022/0301035 A1
(43) Pub. Date: Sep. 22, 2022

(54) INFORMATION PROCESSING APPARATUS AND METHOD, AND PROGRAM

(71) Applicant: Sony Group Corporation, Tokyo (JP)

(72) Inventors: Yousuke KAWANA, Tokyo (JP); Akane KONDO, Tokyo (JP); Itaru SHIMIZU, Tokyo (JP); Tetsuo SAKAMOTO, Tokyo (JP); Keitaro MACHIDA, Tokyo (JP)

(73) Assignee: Sony Group Corporation, Tokyo (JP)

(21) Appl. No.: 17/655,212

(22) Filed: Mar. 17, 2022

(30) Foreign Application Priority Data
Mar. 17, 2021 (JP) 2021-043599

(51) Int. Cl. G06Q 30/06

(52) U.S. Cl. CPC G06Q 30/0631

(57) ABSTRACT

To enable control of a user's action in a manner more suitable for the personality of the user.

A method for controlling an action of a user is set on the basis of the power of the user. For example, the magnitude of the power of the user is determined on the basis of at least one of the status or assets of the user, and the method is set on the basis of the determined magnitude of the power. The present disclosure can be applied to, for example, an information processing apparatus, an electronic device, an information processing method, or a program.

### CROSS REFERENCE TO RELATED APPLICATIONS

This application claims the benefit of Japanese Priority Patent Application JP 2021-043599 filed on Mar. 17, 2021, the entire contents of which are incorporated herein by reference.

### TECHNICAL FIELD

The present disclosure relates to an information processing apparatus and method, and a program, and more particularly to an information processing apparatus and method, and a program that enable a user's action to be controlled in a manner more suitable for the personality of the user.

### BACKGROUND ART

Heretofore, there has been demand for intervention (personalization) tailored to an individual (personality) in various situations of daily life. It is useful to adopt an efficient intervention method in which an appropriate intervention is made for an appropriate user at appropriate timing.

Power is cited as an example of a parameter that indicates personality. Power refers to having much control over others and valuable resources, such as authority and assets.

An experiment has been conducted on the impact of such power possessed by an individual on the individual's action (see, for example, NPL 1). In the experiment described in NPL 1, how to evaluate the value of things (value of things for an individual/others) according to power possessed by the individual was verified through “how much to pay at an auction”.

This experiment showed that a person with greater power offers a higher price than a person with less power when bidding on something for himself/herself at an auction. In addition, it was found that a person with less power offers a higher price than a person with greater power when bidding on something for someone else at an auction. In other words, it was found that power possessed by an individual affects the action of the individual.

### CITATION LIST

### Non Patent Literature

[NPL 1] Derek D. Rucker (Northwestern Univ.) et al, CONSUMER RESEARCH, 2011

### SUMMARY

### Technical Problem

However, heretofore, no consideration has been given to power possessed by an individual in a method for intervening in the action of the individual (that is, a method for controlling the action of the individual).

The present disclosure has been made in view of such circumstances, and is intended to enable a user's action to be controlled in a manner more suitable for the personality of the user.

### Solution to Problem

An information processing apparatus according to an embodiment of the present technology is an information processing apparatus including a control unit that sets a method for controlling an action of a user, on the basis of power of the user.

An information processing method according to an embodiment of the present technology is an information processing method including setting a method for controlling an action of a user, on the basis of power of the user.

A program according to an embodiment of the present technology is a program for causing a computer to function as a control unit that sets a method for controlling an action of a user, on the basis of power of the user.

The information processing apparatus and method, and the program according to the embodiments of the present technology each allow a method for controlling an action of a user to be set on the basis of power of the user.

### BRIEF DESCRIPTION OF DRAWINGS

FIG. 1 is a diagram describing an example of power.

FIG. 2 is a diagram describing another example of power.

FIG. 3 is a diagram describing still another example of power.

FIG. 4 is a block diagram showing a main configuration example of an information processing apparatus.

FIGS. 5A, 5B, and 5C are each a diagram showing an example of a power derivation method.

FIG. 6 is a flowchart describing an example of the flow of an intervention process.

FIG. 7 is a flowchart describing an example of the flow of an intervention details determination process.

FIG. 8 is a diagram describing an example of application to a fan community application.

FIG. 9 is a diagram describing an example of application to a vehicle rental plan proposal service.

FIG. 10 is a block diagram showing a main configuration example of a computer.

### DESCRIPTION OF EMBODIMENTS

Modes for carrying out the present disclosure (hereinafter referred to as embodiments) will be described below. Note that description will be provided in the following order.

1. Power-Based Control over User Action

2. First Embodiment (Information Processing Apparatus)

3. Second Embodiment (First Application Example)

4. Third Embodiment (Second Application Example)

5. Fourth Embodiment (Third Application Example)

6. Fifth Embodiment (Fourth Application Example)

7. Supplementary Notes

### 1. Power-Based Control Over User Action

### <Power>

Heretofore, there has been demand for intervention (personalization) tailored to an individual (personality) in various situations of daily life. It is useful to adopt an efficient intervention method in which an appropriate intervention is made for an appropriate user at appropriate timing.

Power has been proposed as a parameter indicating personality in, for example, NPL 1. Power is an important foundation of the architecture of social hierarchy of people. Power has a broad impact not only on how an individual feels about himself/herself, but also on the kind of relationship the individual has with others and how the individual perceives others. Power affects the degree to which an individual focuses on himself/herself or others. Power reduces the importance of others so as to meet others' needs.

In other words, a person with less power needs to pay attention to others so as to achieve his/her goal and meet his/her needs, but a person with greater power does not. Furthermore, in general, a person with greater power is more interested in himself/herself than in others.

### <Relationship Between Power and Oneself>

A person with greater power depends heavily on his/her own thoughts. For example, a person with greater power often expresses his/her opinion in group discussion. In addition, a person with greater power is less affected by the attitudes and expressions of others. For example, a prison guard in a strong position behaves as if the prison guard is more important than a prisoner in a weak position.

### <Relationship Between Power and Others>

A person with greater power is less interested in others. A person with greater power is less likely to adopt the visual perspective of others, and is less accurate in judging the emotions of others. Authority reduces the accuracy of estimating other people's interest, and increases dependence on stereotypes in evaluating others. A person with greater power focuses his/her efforts on achieving his/her own goal, so that the person with greater power tends to regard others simply as a means to achieve his/her personal goal.

### Example of Power

In an organization, an employee's superior generally has stronger control over both resources and personnel than the employee. Similarly, in a classroom, a professor manages students by grading the students, and owns more resources in the form of knowledge.

### Example of Intervention

As authority extends over people's daily lives, the state of authority and a “sense of powerlessness” are also promoted with ease by a simple change in circumstances or roles, or by a reminder of past cases where an individual possessed or lacked authority.

### <Verification of Impact of Power>

NPL 1 discloses an experiment on the impact of such power possessed by an individual on the individual's action.

In the experiment described in NPL 1, how to evaluate the value of things (value of things for an individual/others) according to power possessed by the individual has been verified through “how much to pay at an auction”.

In this experiment, power refers to having much control over others and valuable resources, such as authority and assets. Then, each participant in the experiment was asked to show each amount to pay for an article at an auction in a case where the participant has greater power than others and a case where the participant has less power than others, and these amounts were compared.

This experiment showed that a person with greater power offers a higher price than a person with less power when bidding on something for himself/herself at an auction.

In addition, it was found that a person with less power offers a higher price than a person with greater power when bidding on something for someone else at an auction.

### <Control Over Individual's Action>

In other words, it was found that power possessed by an individual affects the action of the individual. However, heretofore, no consideration has been given to power possessed by an individual in a method for intervening in the action of the individual (that is, a method for controlling the action of the individual). Therefore, it has been difficult to intervene in a user's action (that is, to control the user's action) in a manner more suitable for the personality of the user.

### <Power-Based Control>

Therefore, a user's action is controlled on the basis of the user's power. For example, in an information processing method, a method for controlling the action of a user is set on the basis of the power of the user. For example, an information processing apparatus includes a control unit that sets a method for controlling the action of a user, on the basis of the power of the user. For example, a program causes a computer to function as a control unit that sets a method for controlling the action of a user, on the basis of the power of the user. It is thus possible to control a user's action in a manner more suitable for the personality of the user.

### 2. First Embodiment

### <Power>

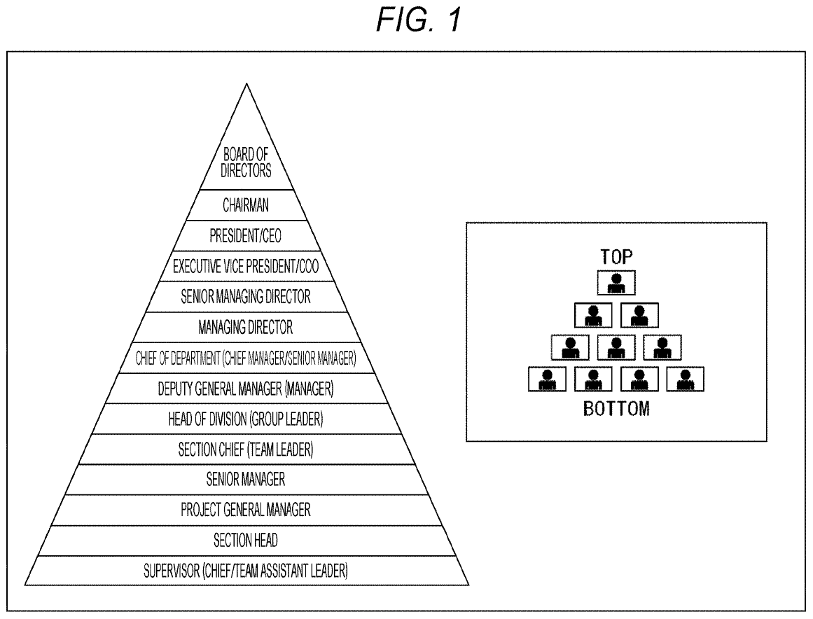

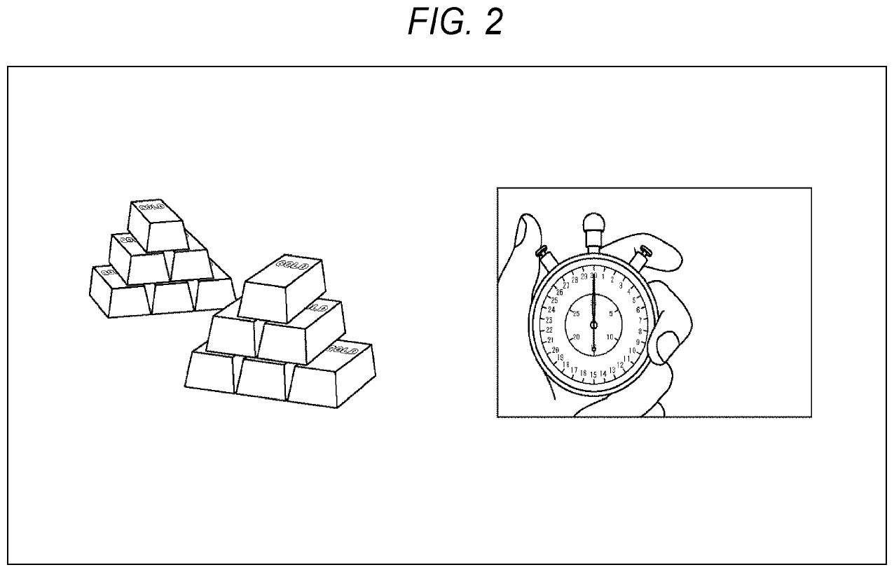

In the present disclosure, power is defined as described above. That is, power refers to ability to control his/her own resources or resources of others. For example, authority and rank (for example, ability to control others, social status, and the number of subordinates) as shown in FIG. 1 can be elements of power. In addition, the degree of economic freedom (for example, the abundance of assets held by a person, such as money, land, and houses) and the degree of time freedom (for example, personality and a lifestyle) as shown in, for example, FIG. 2 can be elements of power.

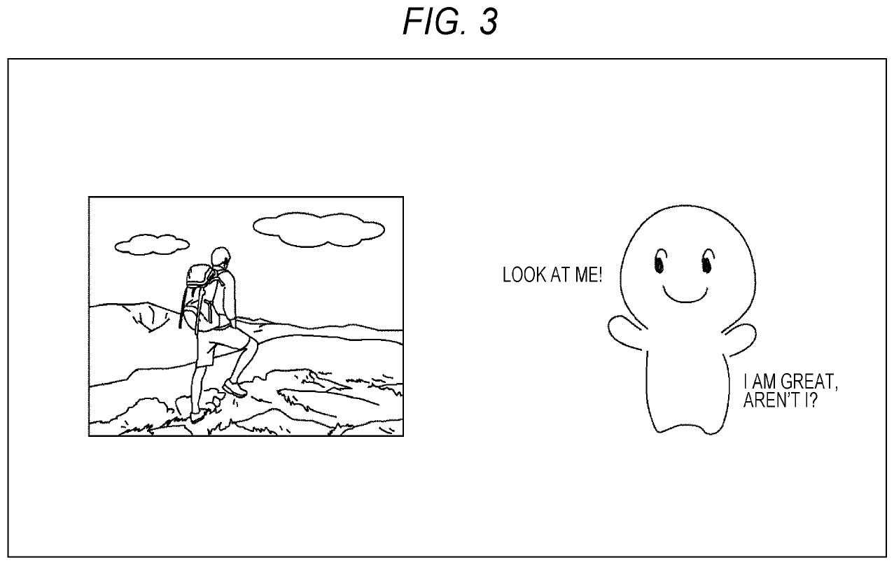

Moreover, the degree of ambition (for example, how big a person's aim, goal, dream, and the like is) and the degree of self-disclosure and self-display as shown in, for example, FIG. 3 can be elements of power.

### Example of Power-Based Intervention

### <Coaching>

A person with less power may have low self-esteem. Therefore, an intervention is made in such a way as to increase power for a person with less power. For example, before a match or an examination, interventions such as presentation of a routine and presentation of a simple task are made for an athlete or student with less power. It can be expected that these interventions will improve the performance of the athlete or student.

### <Observance of Good Manners>

A person with greater power tends to be less interested in others. Therefore, an intervention is made in such a way as to reduce power for a person with greater power.

It is thus possible to cause the person to correctly (highly) evaluate the value of others, others' property, common property, public property, or the like. For example, an intervention is made in such a way as to reduce the power of a user with greater power in sharing economy services such as carsharing. It is thus possible to cause the user to observe good manners in a situation where the user coexists with others. In addition, such an intervention is made for a user with greater power in an online community or the like. It is thus possible to prevent an aggressive action against others or the like. As a result, services can be facilitated.

### <Improvement of Rate of Repeated Use of Service>

Furthermore, an intervention may be made in such a way as to cause a user to feel as if a service received by the user is of high value. For example, an intervention may be made in such a way as to cause a user to feel as if a service received by the user, a person in charge, and property of someone else are of higher value.

Furthermore, in a case where a user inputs recommendation, an intervention may be made such that evaluation to be presented to other users is high. As a result of such an intervention, it is possible to improve the user evaluation of a service and the like, and it can be expected that a rate of repeated use of the service and the like will be increased at the time of ex-post evaluation.

### <Function to be Performed by Conversational AI Agent>

Furthermore, in an interactive service using artificial intelligence (AI), an agent may make an intervention based on the power of a user as described above. For example, when necessary, the agent may make an intervention in such a way as to increase the power of a user with less power. In addition, when necessary, the agent may make an intervention in such a way as to reduce the power of a user with greater power.

### <Configuration of Information Processing Apparatus>

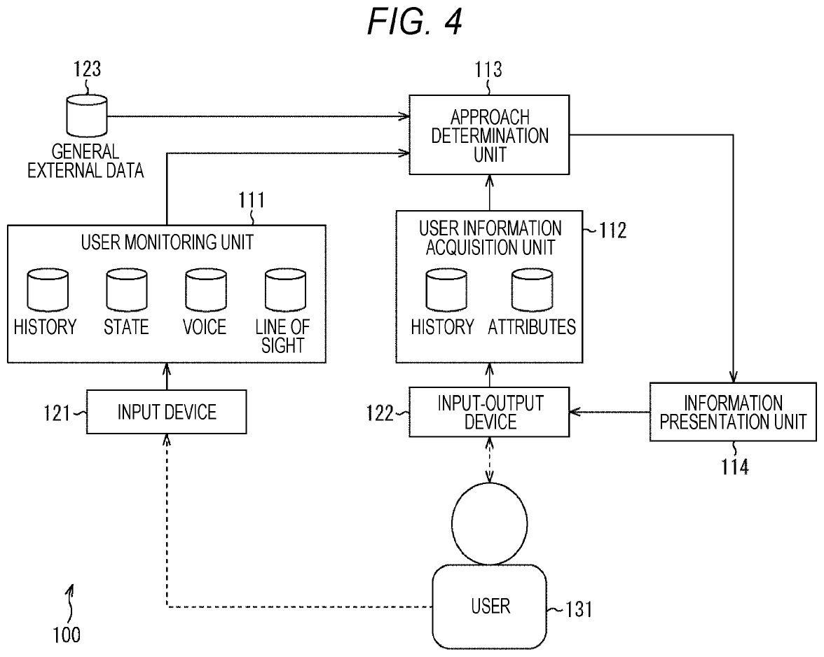

FIG. 4 is a diagram showing a main configuration example of an information processing apparatus to which the present technology has been applied. An information processing apparatus 100 shown in FIG. 4 is an apparatus that provides a service to a user 131 by receiving an input from the user 131 and presenting information to the user 131. Then, at the time of providing the service, the information processing apparatus 100 makes an intervention for the user 131 on the basis of the power of the user 131 as appropriate. That is, the information processing apparatus 100 can control the action of the user 131 on the basis of the power of the user 131.

As shown in FIG. 4, the information processing apparatus 100 includes a user monitoring unit 111, a user information acquisition unit 112, an approach determination unit 113, and an information presentation unit 114. Furthermore, the information processing apparatus 100 includes an input device 121 and an input-output device 122.

For example, the user monitoring unit 111 monitors the user 131 by using the input device 121, and acquires information such as the state of the user 131, the voice of the user 131, and the line of sight of the user 131. For example, the user monitoring unit 111 can monitor the movement of the user 131. For example, the user monitoring unit 111 may monitor the position of each user 131, the number of the users 131, the posture of each user 131, a direction that each user 131 is facing, a direction of the eyes of each user 131, a gesture with the fingers of each user 131, or the like, monitor two or more of these items, or monitor things other than these items on the basis of information supplied from the input device 121.

Furthermore, the user monitoring unit 111 may generate a user's action history on the basis of the result of monitoring as described above. Moreover, the user monitoring unit 111 may identify the user 131 (personal authentication) on the basis of an image, voice, biometric information, or the like detected by the input device 121.

The user monitoring unit 111 supplies the approach determination unit 113 with acquired information regarding the user 131 and the surroundings of the user 131.

The input device 121 includes a sensor device. The sensor device enables the input device 121 to be used to monitor at least one of the user 131 or the surroundings of the user 131 and detect information regarding the user 131 or information regarding the surroundings of the user 131 or both.

Note that a sensor device that detects any information may be used as the sensor device described above. For example, the input device 121 may include a camera that detects an image. Furthermore, the input device 121 may include a microphone that detects voice. In addition, the input device 121 may be a polarization sensor. Moreover, the input device 121 may be a time-of-flight (ToF) sensor. Furthermore, the input device 121 may be a heat sensor that detects heat, such as a so-called thermography camera. In addition, the input device 121 may be an eye tracker that detects a direction of the eyes of the user 131. Moreover, the input device 121 may be a microphone array including a plurality of microphones. Furthermore, the input device 121 may be a heart rate sensor that detects the heart rate of the user 131. In addition, the input device 121 may be a wristband-type pulse sensor that detects the pulse of the user 131.

Note that the input device 121 may include a plurality of sensor devices. Furthermore, the input device 121 may include two or more types of sensor devices. For example, the input device 121 may be a head-mounted display or the like.

The input device 121 supplies information detected by the sensor device to the user monitoring unit 111. That is, any type of information may be supplied to the user monitoring unit 111. For example, an image, voice, or other information may be supplied. Furthermore, two or more types of information may be supplied from the input device 121 to the user monitoring unit 111. For example, an image and voice may be supplied from the input device 121 to the user monitoring unit 111.

The user information acquisition unit 112 acquires information that the user 131 has input by operating the input-output device 122. That is, the user information acquisition unit 112 receives an action (operation of the input-output device 122) taken by the user 131 via the input-output device 122, and acquires information regarding the action. The information regarding the action of the user 131 to be acquired by the user information acquisition unit 112 may contain any items. For example, the information regarding the action of the user 131 may contain information input by the user 131, such as the attributes of the user 131 (personal information of the user 131). In addition, the information regarding the action of the user 131 may contain information indicating details of operation that the user 131 performed on the input-output device 122 (which button was pressed, which option was chosen, or the like). For example, the user information acquisition unit 112 may acquire, as the history of the action of the user 131, the history of the operation that the user 131 performed on the input-output device 122. Of course, the information regarding the action of the user 131 may contain information other than these kinds of information. The user information acquisition unit 112 supplies the acquired information (information input by the user 131) to the approach determination unit 113.

The input-output device 122 includes a device that can serve as a user interface for the user 131, through which information can be input and output. That is, the input-output device 122 provides information to the user 131, and receives information input by the user 131.

For example, the input-output device 122 presents the user 131 with information supplied from the information presentation unit 114, as an image, voice, or the like. Any information may be presented to the user 131. For example, information other than an image or voice, such as heat or vibration, may be presented to the user 131. Furthermore, the input-output device 122 receives an operation by the user 131, and receives an image or voice input by the user 131. The input-output device 122 supplies the received information to the user information acquisition unit 112. Any type of information may be received by the input-output device 122. That is, the input-output device 122 has both an information output function such as that of a monitor or a speaker and an information input function such as that of a keyboard, a mouse, a button, a touch panel, a camera, or a microphone. For example, the input-output device 122 may include a portable terminal device such as a smartphone or a tablet device. Furthermore, the input-output device 122 may include a personal computer that includes a monitor, a keyboard, a mouse, a microphone, and the like. Of course, the input-output device 122 may include a device other than these devices.

The approach determination unit 113 sets a method of intervention for the user 131 (a method for controlling an action taken by the user 131) based on the power of the user 131. For example, the approach determination unit 113 acquires the information supplied from the user monitoring unit 111. As described above, this information is information regarding the user 131 or information regarding the surroundings of the user 131 or both.

Furthermore, the approach determination unit 113 acquires the information supplied from the user information acquisition unit 112. As described above, this information is information that the user 131 has input by operating the input-output device 122. For example, this information may contain information regarding the personality of the user 131 and an action taken by the user 131.

Moreover, the approach determination unit 113 can acquire general external data 123 from outside the information processing apparatus 100. The general external data 123 contain information to be used for setting the intervention method, and is supplied from outside the information processing apparatus 100. Note that any information may be contained in the general external data 123. That is, the general external data 123 may contain any information as long as the information is used for setting the intervention method.

The approach determination unit 113 derives the power of the user 131 on the basis of these pieces of acquired information, and sets a method for intervening in an action taken by the user 131 (controlling the action taken by the user 131) on the basis of the derived power. For example, the approach determination unit 113 may determine the magnitude of the power of the user 131 on the basis of at least one of the status or assets of the user 131 indicated by these pieces of acquired information, and set the intervention method on the basis of the determined magnitude of the power.

In addition, the approach determination unit 113 may set the intervention method on the basis of the purpose of the action of the user 131 indicated by these pieces of acquired information. Moreover, the approach determination unit 113 may set the intervention method on the basis of the history of the action of the user 131 indicated by these pieces of acquired information. In addition, the approach determination unit 113 may set the intervention method on the basis of at least one of the state of the user 131, the voice of the user 131, or the line of sight of the user 131 indicated by these pieces of acquired information.

Then, the approach determination unit 113 supplies necessary information to the information presentation unit 114 so that an intervention is made by use of the set method. The necessary information may contain any information. For example, the necessary information may contain an image or voice, or both. That is, the approach determination unit 113 may set, as the intervention method, a method in which at least one of an image or voice is presented to the user 131.

Furthermore, at that time, the approach determination unit 113 may control the timing of intervention (timing of information presentation). For example, the approach determination unit 113 may supply information to the information presentation unit 114 and cause the information presentation unit 114 to present the information at a set timing.

The information presentation unit 114 performs processing related to presentation of information to the user 131. For example, the information presentation unit 114 acquires information supplied from the approach determination unit 113, and presents the information to the user 131. For example, the information presentation unit 114 may present the user 131 with information according to the intervention method set by the approach determination unit 113, by using at least one of an image or voice. For example, the information presentation unit 114 may include an output device such as a projector that presents visual information or a speaker that outputs voice. Furthermore, the information presentation unit 114 may present the information by using the input-output device 122. For example, the information presentation unit 114 may supply the input-output device 122 with information supplied from the approach determination unit 113, and cause the input-output device 122 to present the user 131 with the information as an image, voice, or the like.

### <Power Derivation Method>

Parameters of power include parameters to be subjectively perceived and parameters to be judged objectively. Either or both of the parameters are used depending on use cases.

Examples of the parameters to be subjectively perceived include a result of a questionnaire for checking stress levels or the like to be conducted by a company, being under chronic and prolonged stress (and it is estimated that the stress has been caused by human relationships), a result of a personality test of the Big Five personality traits or the like, whether or not a person has a tendency to control others, a desire to dominate, whether the desire to dominate has been satisfied, a dialogue history sensed by a smart speaker, and a log of actions at a company or the like. Any one of these items may be applied, or two or more of these items may be applied in combination. Furthermore, parameters other than these may be applied.

In addition, examples of the parameters to be judged objectively include general social status information (from customer information or the like), a social score (the influence of remarks and the number of followers), a social graph, a credit score, a purchase history, a dialogue history sensed by a smart speaker, and a log of actions at a company or the like. Any one of these items may be applied, or two or more of these items may be applied in combination. Furthermore, parameters other than these may be applied.

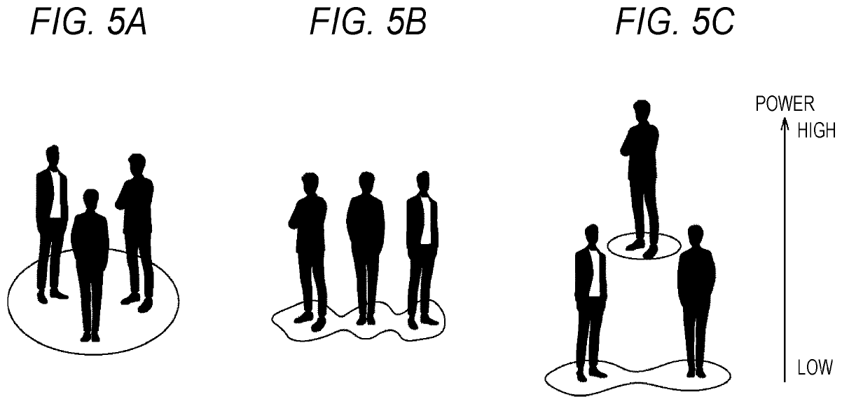

In addition, the power of each person and the person's relationship with others may be estimated from behavioral characteristics of the person and others including people around the person. For example, in a case where a large number of people have gathered in one place as shown in FIG. 5A or stand side by side as shown in FIG. 5B, it can be estimated that the difference in power between individuals is relatively small. In contrast, in a case where only some people (for example, only one person) are higher in status or the like than others as shown in, for example, FIG. 5C, it can be estimated that the difference in power between individuals is relatively large. Of course, these are just examples, and the power of each person and the person's relationship with others may be estimated on the basis of any information.

### <Method of Intervention>

The approach determination unit 113 may use any method to intervene in an action taken by the user 131 on the basis of power. For example, the approach determination unit 113 may make an intervention in such a way as to reduce the power of the user 131. For example, the approach determination unit 113 may make an intervention in such a way as to remind the user 131 of an object that controls the user 131. For example, the approach determination unit 113 may remind the user 131 of his superior, wife, or parent. Furthermore, the approach determination unit 113 may make an intervention in such a way as to cause the user 131 to feel unable to control resources. For example, an AI agent may reprove the user 131. In addition, the approach determination unit 113 may present a person of higher position to the user 131. For example, the state of a more highly ranked player may be shown in a game. Furthermore, the user 131 may play a match against a player who is a bit more highly ranked. An intervention may be made by use of any method. A method other than a method in which the user 131 is put under stress may be used. For example, an intervention may be made in such a way as to cause the user 131 to change his/her perspective.

Furthermore, for example, the approach determination unit 113 may make an intervention in such a way as to increase the power of the user 131. For example, the approach determination unit 113 may make the user 131 aware that the user 131 has been successful in controlling various things. For example, the user 131 may be asked to solve a simple problem or perform a simple task. In addition, the AI agent may cause the user 131 to feel controlled or to obey the AI agent through dialogue. Alternatively, the AI agent may cause the user 131 to give the AI agent a command, and follow the given command through dialogue. Furthermore, for example, the approach determination unit 113 may make an intervention in such a way as to cause the user 131 to recognize that the user 131 has an influence on others. For example, the approach determination unit 113 may cause the user 131 to give advice and to think that the advice is useful or feel that the advice affects others. Furthermore, the approach determination unit 113 may visualize a social score to show that social connection exists. For example, “Like” may be displayed.

### <Flow of Intervention Process>

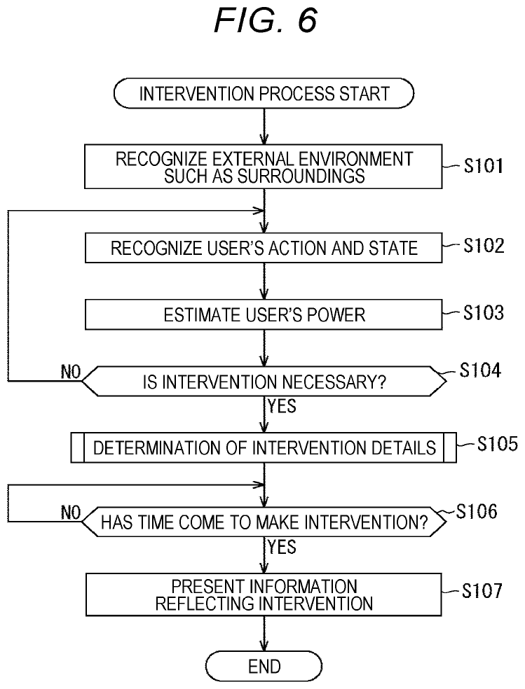

An example of the flow of an intervention process to be performed by the information processing apparatus 100 will be described with reference to a flowchart of FIG. 6. When the intervention process is started, the user monitoring unit 111 of the information processing apparatus 100 recognizes external environment such as the surroundings of the user 131 via the input device 121 in step S101.

In step S102, the user information acquisition unit 112 recognizes the user's action and state via the input-output device 122.

In step S103, the approach determination unit 113 estimates the power of the user 131 on the basis of information acquired in steps S101 and S102.

In step S104, the approach determination unit 113 determines whether or not intervention is necessary, on the basis of the power of user 131 estimated in step S103.

In a case where it is determined that intervention is not necessary, the process returns to step S102.

Furthermore, in a case where it is determined in step S104 that intervention is necessary, the process proceeds to step S105.

In step S105, the approach determination unit 113 determines a method of intervention on the basis of the power of the user 131 estimated in step S103.

In step S106, the approach determination unit 113 determines whether or not the time has come to make an intervention. In a case where it is determined that the time has not come to make an intervention, the process is kept on standby. In a case where it is determined that the time has come to make an intervention, the process proceeds to step S107.

In step S107, the information presentation unit 114 presents information reflecting details of the intervention determined in step S105. When the processing in step S107 is completed, the intervention process ends.

### <Flow of Intervention Details Determination Process>

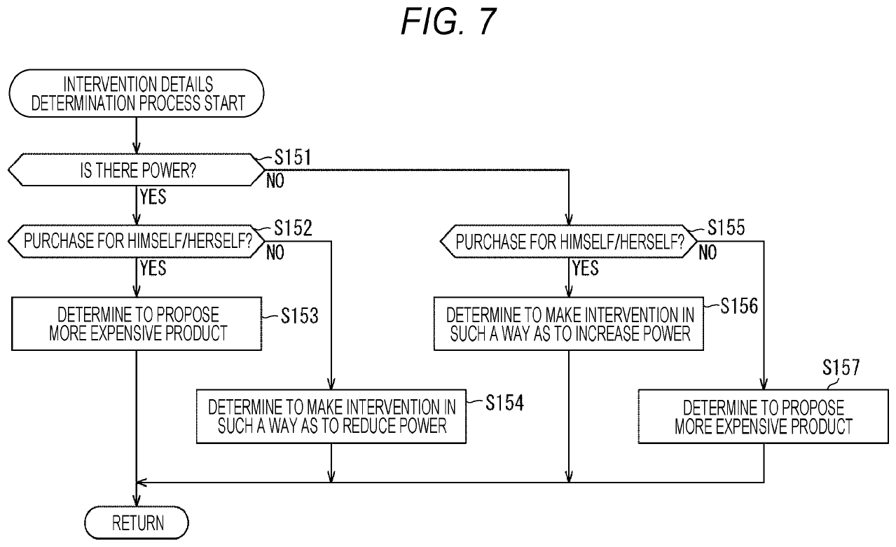

An example of the flow of an intervention details determination process to be performed in step S105 of FIG. 6 will be described with reference to a flowchart of FIG. 7.

When the intervention details determination process is started, the approach determination unit 113 determines in step S151 whether or not there is power. In a case where it is determined that there is power (that is, the power is great), the process proceeds to step S152.

In step S152, the approach determination unit 113 determines whether or not an action that the user 131 is about to take is a purchase for himself/herself.

In a case where it is determined that the action is a purchase for himself/herself (that is, a purchase for the user 131 himself/herself), the process proceeds to step S153. In the case of a purchase for himself/herself, a person with greater power tends to purchase a more expensive product (or service) than a person with less power. Therefore, in step S153, the approach determination unit 113 determines to propose a more expensive product (or service) that is likely to be more suitable for the desire of the user 131 with greater power (the user 131 is likely to purchase).

It is thus possible to expect that the user 131 will purchase a more expensive product (or service) for himself/herself. When the processing in step S153 is completed, the intervention details determination process ends, and the process returns to FIG. 6.

Furthermore, in a case where it is determined in step S152 that the action is a purchase for someone else, the process proceeds to step S154. In the case of a purchase for someone else, a person with greater power tends to purchase a less expensive product (or service) than a person with less power. Therefore, the approach determination unit 113 determines in step S154 to make an intervention in such a way as to reduce the power of the user 131.

For example, as such an intervention, the approach determination unit 113 may determine to cause the information presentation unit 114 to present the user 131 with at least one of an image or voice. For example, the approach determination unit 113 may determine to present the user 131 with an existence having greater power than the user 131 (for example, nature, God, a paranormal phenomenon, or the universe) by using at least one of the image or the voice.

Furthermore, for example, the approach determination unit 113 may determine to present the user 131 with music that is less likely to raise the spirits of the user 131 (for example, slow-tempo music or low-pitched music). Moreover, the approach determination unit 113 may determine to present a cool color image to the user 131. Of course, the approach determination unit 113 may determine to present both the music and the image to the user 131. When the processing in step S154 is completed, the intervention details determination process ends, and the process returns to FIG. 6.

It is thus possible to expect that the user 131 will purchase a more expensive product (or service) for someone else.

Furthermore, in a case where it is determined in step S151 that there is no power (that is, the power is weak), the process proceeds to step S155. In step S155, the approach determination unit 113 determines whether or not an action that the user 131 is about to take is a purchase for himself/herself.

In a case where it is determined that the action is a purchase for himself/herself, the process proceeds to step S156. In the case of a purchase for himself/herself, a person with less power tends to purchase a less expensive product (or service) than a person with greater power. Therefore, the approach determination unit 113 makes an intervention in step S156 in such a way as to increase the power of the user 131.

For example, as such an intervention, the approach determination unit 113 may determine to cause the information presentation unit 114 to present the user 131 with at least one of an image or voice. For example, the approach determination unit 113 may determine to increase the power of the user 131 by causing the user 131 to strongly recognize his/her own power by use of at least one of the image or the voice. For example, the approach determination unit 113 may determine to cause the user 131 to solve a simple problem or give a positive evaluation by using at least one of the image or the voice.

Furthermore, the approach determination unit 113 may determine to present the user 131 with music that is likely to raise the spirits of the user 131 (for example, up-tempo music or high-pitched music). Moreover, the approach determination unit 113 may determine to present a warm color image to the user 131. Of course, the approach determination unit 113 may determine to present both the music and the image to the user 131. When the processing in step S156 is completed, the intervention details determination process ends, and the process returns to FIG. 6.

It is thus possible to expect that the user 131 will purchase a more expensive product (or service) for himself/herself.

Furthermore, in a case where it is determined in step S155 that the action is a purchase for someone else, the process proceeds to step S157. In the case of a purchase for someone else, a person with less power tends to purchase a more expensive product (or service) than a person with greater power. Therefore, in step S157, the approach determination unit 113 determines to propose a more expensive product (or service) that is likely to be more suitable for the desire of the user 131 with less power (the user 131 is likely to purchase). When the processing in step S157 is completed, the intervention details determination process ends, and the process returns to FIG. 6.

It is thus possible to expect that the user 131 will purchase a more expensive product (or service) for someone else.

### 3. Second Embodiment

### First Application Example

An example of application to a general purchasing system has been described above, but the present technology can be applied to any system. For example, the present technology may be applied to dynamic pricing for ticket sales at a stadium. For example, a person with greater power tends to pay a price for something purchased for himself/herself, so that an intervention may be made in such a way as to set a higher price. In addition, a person with less power tends to pay a price for something purchased for someone else. Therefore, in a case where the person purchases tickets including a ticket for someone else, an intervention may be made in such a way as to raise a price.

In addition, the present technology may be applied to systems in the field of advertising (targeting and contents). The present technology can also be applied to systems in the product and service sales industries that offer goods other than consumer goods, and services, such as houses, automobiles, and travel. In addition, the present technology can also be applied to systems for services that deal in products that may be purchased for others. Moreover, the present technology can also be applied to systems for, for example, recommendations on an online shopping site and information provision support at the time of customer service at stores.

### 4. Third Embodiment

### Second Application Example

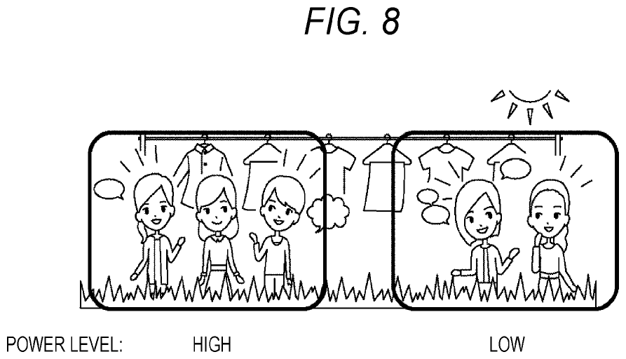

Furthermore, the present technology may also be applied to, for example, a fan community application. For example, as shown in FIG. 8, people who want to occasionally participate in a community and have fun in moderation and people who want to talk more deeply about something together in the community every day may be classified according to power levels into groups. The power levels may be defined on the basis of, for example, a blockchain or the amount of used virtual currency. So-called diehard fans who have been participating in the community with great enthusiasm may adversely affect participation of new entrants such that, for example, the new entrants hesitate to participate in the community in a case where, for example, close relationships between such fans have been established. However, it is possible to prevent such an adverse effect by taking an approach as described above, so that barriers for new entrants can be lowered. Furthermore, in the case of games, although it is generally difficult to perform grouping before a game starts (outside the game world), the present technology enables grouping to be performed earlier than the start of a game. This is because a fan community allows grouping to be performed before a subscription to a service (in the real world). It is thus possible to expect activation of communities and an increase in the number of participants.

### 5. Fourth Embodiment

### Third Application Example

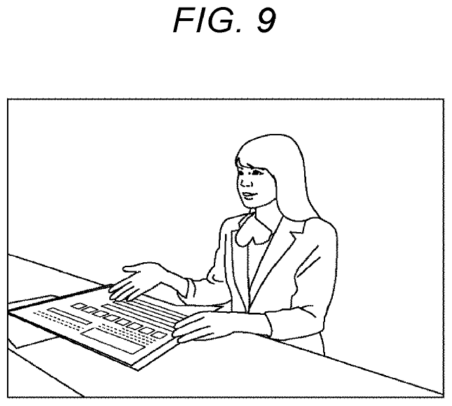

In addition, the present technology may be applied to proposal or modification of a vehicle rental plan. For example, assume that when a customer rents a vehicle, a shop (system) presents a rental plan to the customer as shown in FIG. 9. In this case, the shop (system) may first grasp the power of a user and propose or modify the vehicle rental plan according to the power.

For example, a person with less power tends to yield to another vehicle, increase his/her following distance, and allow another vehicle to cut into his/her lane.

Furthermore, these tendencies may be likely to cause a traffic jam. In contrast, a person with greater power tends to avoid yielding to another vehicle and reduce his/her following distance. These tendencies may be likely to cause a minor collision. Furthermore, a person with greater power tends to choose a luxury vehicle. In this way, user's evaluations of a user's own value and the value of others are estimated on the basis of the magnitude of power. In addition, whether or not the user adopts a humble attitude to others (other vehicles, pedestrians, and traffic regulations) is estimated on the basis of the magnitude of power. The shop (system) determines a plan to be presented to the user on the premise of such tendencies based on power. Note that any method may be used to estimate power. For example, power may be estimated on the basis of the user's driving tendency or the like, or may be estimated on the basis of the user's personal information or the like.

It is thus possible to propose a plan in such a way as to, for example, prevent an increase in the risk of accidents. It is possible to know, in advance, driving tendencies of users who have used the service in the past. Meanwhile, it is also possible to estimate driving tendencies of other users in advance.

### 6. Fifth Embodiment

### Fourth Application Example

In addition, an intervention may be made by an agent in consideration of a difference in power between a plurality of persons. For example, an intervention may be made in consideration of power in a situation where there are a plurality of persons and an agent, such as a situation where there are a person with greater power, a person with less power, and an agent or a situation where there are a plurality of persons, a system (shop), and an agent.

For example, in a case where a husband with less power and a wife with greater power have come to an unmanned store for shopping, the way of presentation may be changed depending on whether the shopping is for themselves or someone else. For example, goods may be recommended according to a judgment made by a person with greater power. Alternatively, a higher price may be offered.

Furthermore, in a case where an e-mail is sent from a person with greater power to a person with less power, an intervention may be made by an e-mail sending and receiving system or the like so as to make up the power difference. For example, communication may be activated by an intervention made in such a way as to enhance the power of a person with less power. Moreover, in a system that enables two or more people to have a conversation or a meeting via a network, the system may present information that supports the people's conversation by picking up context from the conversation.

### 7. Supplementary Notes

### <Computer>

A series of processes described above can be implemented by hardware, or can be implemented by software. In a case where the series of processes is implemented by software, a program included in the software is installed on a computer. Here, examples of the computer include a computer incorporated in dedicated hardware and a computer, such as a general-purpose personal computer, capable of performing various functions by installation of various programs.

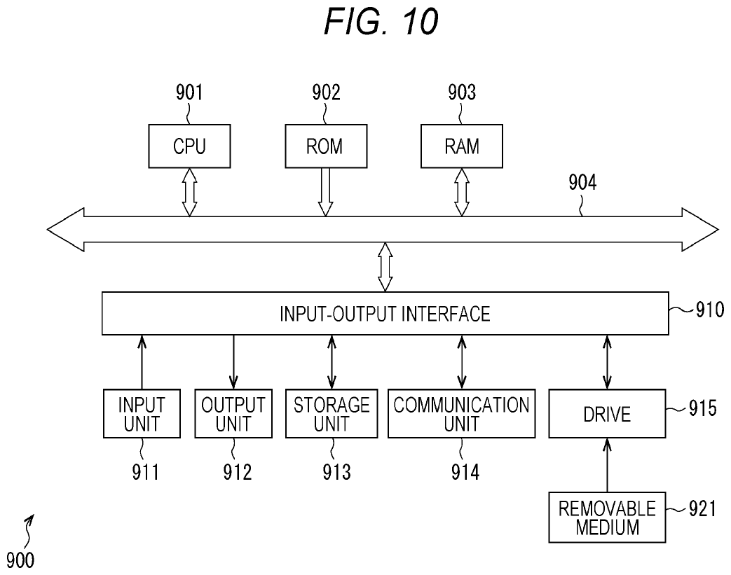

FIG. 10 is a block diagram showing a configuration example of hardware of a computer that performs the series of processes described above by means of a program. In a computer 900 shown in FIG. 10, a central processing unit (CPU) 901, a read only memory (ROM) 902, and a random access memory (RAM) 903 are interconnected via a bus 904.

The bus 904 is also connected to an input-output interface 910. The input-output interface 910 is connected to an input unit 911, an output unit 912, a storage unit 913, a communication unit 914, and a drive 915.

The input unit 911 includes, for example, a keyboard, a mouse, a microphone, a touch panel, and an input terminal. The output unit 912 includes, for example, a display, a speaker, and an output terminal. The storage unit 913 includes, for example, a hard disk, a RAM disk, and a nonvolatile memory. The communication unit 914 includes, for example, a network interface. The drive 915 drives a removable medium 921 such as a magnetic disk, an optical disk, a magneto-optical disk, or a semiconductor memory. In the computer configured as described above, the CPU 901 loads a program stored in, for example, the storage unit 913 into the RAM 903 via the input-output interface 910 and the bus 904, and executes the program, so that the series of processes described above is performed. Furthermore, data and the like necessary for various types of processing to be performed by the CPU 901 are also stored in the RAM 903 as appropriate.

A program to be executed by the computer can be applied after being recorded on, for example, the removable medium 921 as a package medium or the like. In this case, it is possible to install the program in the storage unit 913 via the input-output interface 910 by mounting the removable medium 921 on the drive 915.

Furthermore, the program can also be provided via a wired or wireless transmission medium such as a local area network, the Internet, or digital satellite broadcasting. In this case, the program can be received by the communication unit 914 and installed in the storage unit 913.

In addition, it is also possible to install the program in the ROM 902 or the storage unit 913 in advance.

### Examples of Configurations to which Present Technology can be Applied

The present technology can be applied to any configurations. For example, the present technology may be applied to electronic devices and systems.

Furthermore, for example, the present technology can also be implemented as a partial configuration of a device. Examples of such a device include a processor (for example, a video processor) as a system large-scale integration (LSI) or the like, a module (for example, a video module) using a plurality of processors or the like, a unit (for example, a video unit) using a plurality of modules or the like, and a set (for example, a video set) in which another function has been further added to the unit.

In addition, for example, the present technology can also be applied to a network system including a plurality of devices. For example, the present technology may be implemented as cloud computing in which a plurality of devices shares duties and performs processing in collaboration with each other via a network. For example, the present technology may be implemented in cloud services that provide services related to images (moving images) to any terminals such as computers, audiovisual (AV) devices, portable information processing terminals, and Internet of things (IoT) devices.

Note that, in the present specification, the term “system” refers to a set of multiple constituent elements (devices, modules (parts), and the like), and it does not matter whether or not all the constituent elements are in the same housing. Therefore, a plurality of devices stored in separate housings and connected via a network, and a single device including a plurality of modules stored in a single housing are both considered systems.

<Fields and Application Purposes to which Present Technology can be Applied>

Systems, devices, processing units, and the like to which the present technology has been applied can be used in any fields such as traffic, medical care, crime prevention, agriculture, the livestock industry, mining, beauty care, factories, home appliances, weather, and nature monitoring. Furthermore, such systems, devices, processing units, and the like can be used for any purposes.

For example, the present technology can be applied to systems and devices to be used for providing content and the like to be viewed. Furthermore, for example, the present technology can also be applied to systems and devices to be used for traffic purposes such as supervision of traffic conditions and control of automated driving. Moreover, for example, the present technology can also be applied to systems and devices to be used for security purposes. In addition, for example, the present technology can be applied to systems and devices to be used for automatic control of machines and the like. Moreover, for example, the present technology can also be applied to systems and devices to be used for agriculture and the livestock industry. Furthermore, the present technology can also be applied to systems and devices for monitoring, for example, natural conditions such as volcanoes, forests and the ocean, and wildlife. Moreover, for example, the present technology can also be applied to systems and devices to be used for sports.

### <Other>

Note that embodiments of the present technology are not limited to the above-described embodiments, and various modifications can be made without departing from the gist of the present technology.

For example, a constituent element described as a single device (or processing unit) may be divided and configured as a plurality of devices (or processing units), and vice versa. That is, constituent elements described above as a plurality of devices (or processing units) may be integrated and configured as a single device (or processing unit). Furthermore, as a matter of course, a constituent element other than the constituent elements described above may be added to the configuration of each device (or each processing unit). Moreover, as long as the configuration and operation of the entire system remains substantially unchanged, some of constituent elements of a device (or processing unit) may be included in the configuration of another device (or another processing unit).

Furthermore, for example, the above-described program may be executed in any device. In this case, the device just needs to be configured such that the device has a necessary function (functional block or the like), and can obtain necessary information.

Furthermore, for example, each step of a single flowchart may be performed by a single device or alternatively, a plurality of devices may share duties and perform each step. Moreover, in a case where a single step includes a plurality of processes, the plurality of processes may be performed by a single device or alternatively, a plurality of devices may share duties and perform the plurality of processes. In other words, a plurality of processes included in a single step can be performed as processes of a plurality of steps, and vice versa. That is, processes described as a plurality of steps can be collectively performed as a single step.

Furthermore, for example, a program to be executed by a computer may be designed such that processes of steps in program description are performed on a time-series basis in accordance with the order described in the present specification; the processes are performed in parallel; or the processes are performed separately at necessary timings at which, for example, a call is made. That is, as long as there is no conflict, the process of each step may be performed in an order different from the above-described order. Moreover, the program may also be designed such that the processes of the steps in the program description are performed in parallel with processes of another program, or performed in combination with processes of another program.

Furthermore, for example, a plurality of techniques related to the present technology can be implemented independently as separate techniques as long as there is no conflict. As a matter of course, it is also possible to use and implement any two or more techniques of the present technology together. For example, it is also possible to implement some or all of techniques of the present technology described in any one of the embodiments in combination with some or all of techniques of the present technology described in another embodiment. Furthermore, it is also possible to use and implement a part or the whole of any technique of the present technology described above together with another technique not described above.

Note that the present technology can also adopt the following configurations.

(1) An information processing apparatus including: a control unit that sets a method for controlling an action of a user, on the basis of power of the user.

(2) The information processing apparatus according to (1), in which

the control unit determines magnitude of the power of the user on the basis of at least one of a status or assets of the user, and sets the method on the basis of the determined magnitude of the power.

(3) The information processing apparatus according to (2), in which

the control unit sets the method also on the basis of a purpose of the action of the user.

(4) The information processing apparatus according to (3), in which

the control unit sets, as the method, a method for controlling the action of the user by presenting the user with at least one of an image or voice.

(5) The information processing apparatus according to (4), in which

in a case where the user has greater power and the action of the user is an action for someone else, the control unit sets, as the method, a method for reducing the power of the user.

(6) The information processing apparatus according to (5), in which

the control unit sets, as the method, a method for reducing the power of the user by presenting the user with an existence having greater power than the user by use of at least one of the image or the voice.

(7) The information processing apparatus according to (6), in which

the control unit sets, as the method, a method for presenting the user with slow-tempo and low-pitched music or a cool color image or both.

(8) The information processing apparatus according to any one of (4) to (7), in which

in a case where the user has less power and the action of the user is an action for the user himself/herself, the control unit sets, as the method, a method for increasing the power of the user.

(9) The information processing apparatus according to (8), in which

the control unit sets, as the method, a method for increasing the power of the user by causing the user to more strongly recognize the user's own power by use of at least one of the image or the voice.

(10) The information processing apparatus according to (9), in which

the control unit sets, as the method, a method for presenting the user with up-tempo and high-pitched music or a warm color image or both.

(11) The information processing apparatus according to any one of (4) to (10), in which

in a case where the user has greater power and the action of the user is a purchase of a product or service for the user himself/herself, the control unit sets, as the method, a method for presenting the user with a more expensive product or service.

(12) The information processing apparatus according to any one of (4) to (11), in which

in a case where the user has less power and the action of the user is a purchase of a product or service for someone else, the control unit sets, as the method, a method for presenting the user with a more expensive product or service.

(13) The information processing apparatus according to any one of (4) to (12), further including:

an information presentation unit that presents the user with information according to the method set by the control unit, by using at least one of the image or the voice.

(14) The information processing apparatus according to any one of (3) to (13), in which

the control unit sets the method also on the basis of a history of the action of the user.

(15) The information processing apparatus according to (14), further including:

a user information acquisition unit that receives the action taken by the user, and acquires the history of the action as information on the user,

in which the control unit sets the method on the basis of the history of the action of the user, the history being acquired by the user information acquisition unit.

(16) The information processing apparatus according to any one of (3) to (15), in which

the control unit sets the method also on the basis of at least one of a state of the user, a voice of the user, or a line of sight of the user.

(17) The information processing apparatus according to (16), further including:

a user monitoring unit that monitors the user, and acquires at least one of the state of the user, the voice of the user, or the line of sight of the user,

in which the control unit sets the method on the basis of the at least one of the state of the user, the voice of the user, or the line of sight of the user acquired by the user monitoring unit.

(18) The information processing apparatus according to any one of (1) to (17), in which

the control unit further sets a timing for controlling the action of the user.

(19) An information processing method including: setting a method for controlling an action of a user, on the basis of power of the user.

(20) A program for causing a computer to function as:

a control unit that sets a method for controlling an action of a user, on the basis of power of the user.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100 Information processing apparatus
111 User monitoring unit
112 User information acquisition unit
113 Approach determination unit
114 Information presentation unit
121 Input device
122 Input-output device
123 General external data
131 User
900 Computer

1. An information processing apparatus comprising:
a control unit that sets a method for controlling an action of a user, on a basis of power of the user.

2. The information processing apparatus according to claim 1, wherein
the control unit determines magnitude of the power of the user on a basis of at least one of a status or assets of the user, and sets the method on a basis of the determined magnitude of the power.

3. The information processing apparatus according to claim 2, wherein
the control unit sets the method also on a basis of a purpose of the action of the user.

4. The information processing apparatus according to claim 3, wherein
the control unit sets, as the method, a method for controlling the action of the user by presenting the user with at least one of an image or voice.

5. The information processing apparatus according to claim 4, wherein
in a case where the user has greater power and the action of the user is an action for someone else, the control unit sets, as the method, a method for reducing the power of the user.

6. The information processing apparatus according to claim 5, wherein
the control unit sets, as the method, a method for reducing the power of the user by presenting the user with an existence having greater power than the user by use of at least one of the image or the voice.

7. The information processing apparatus according to claim 6, wherein
the control unit sets, as the method, a method for presenting the user with slow-tempo and low-pitched music or a cool color image or both.

8. The information processing apparatus according to claim 4, wherein
in a case where the user has less power and the action of the user is an action for the user himself/herself, the control unit sets, as the method, a method for increasing the power of the user.

9. The information processing apparatus according to claim 8, wherein
the control unit sets, as the method, a method for increasing the power of the user by causing the user to more strongly recognize the user's own power by use of at least one of the image or the voice.

10. The information processing apparatus according to claim 9, wherein
the control unit sets, as the method, a method for presenting the user with up-tempo and high-pitched music or a warm color image or both.

11. The information processing apparatus according to claim 4, wherein
in a case where the user has greater power and the action of the user is a purchase of a product or service for the user himself/herself, the control unit sets, as the method, a method for presenting the user with a more expensive product or service.

12. The information processing apparatus according to claim 4, wherein
in a case where the user has less power and the action of the user is a purchase of a product or service for someone else, the control unit sets, as the method, a method for presenting the user with a more expensive product or service.

13. The information processing apparatus according to claim 4, further comprising:
an information presentation unit that presents the user with information according to the method set by the control unit, by using at least one of the image or the voice.

14. The information processing apparatus according to claim 3, wherein
the control unit sets the method also on a basis of a history of the action of the user.

15. The information processing apparatus according to claim 14, further comprising:
a user information acquisition unit that receives the action taken by the user, and acquires the history of the action as information on the user,
wherein the control unit sets the method on a basis of the history of the action of the user, the history being acquired by the user information acquisition unit.

16. The information processing apparatus according to claim 3, wherein
the control unit sets the method also on a basis of at least one of a state of the user, a voice of the user, or a line of sight of the user.

17. The information processing apparatus according to claim 16, further comprising:
a user monitoring unit that monitors the user, and acquires at least one of the state of the user, the voice of the user, or the line of sight of the user,
wherein the control unit sets the method on a basis of the at least one of the state of the user, the voice of the user, or the line of sight of the user acquired by the user monitoring unit.

18. The information processing apparatus according to claim 1, wherein
the control unit further sets a timing for controlling the action of the user.

19. An information processing method comprising:
setting a method for controlling an action of a user, on a basis of power of the user.

20. A program for causing a computer to function as:
a control unit that sets a method for controlling an action of a user, on a basis of power of the user.
